(19) United States
(12) Patent Application Publication
(10) Pub. No.: US 2010/0325967 A1
(43) Pub. Date: Dec. 30, 2010

(54) LOAD SENSING MAGNETIC LOCK

(76) Inventors: David J. Pearson, Sterling Heights, MI (US); Edward J. Stull, Oxford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/816,767

(22) Filed: Jun. 16, 2010

Related U.S. Application Data
(60) Provisional application No. 61/187,390, filed on Jun. 16, 2009.

(51) Int. Cl. E05C 19/16; E06B 7/00

(52) U.S. Cl. 49/503; 292/251.5

(57) ABSTRACT

A magnetic lock assembly includes an electromagnetic mounted to a fixed portion strike plate mounted to a movable closure member. The electromagnet is constantly powered to maintain a closed and locked position and therefore requires a constant flow of energy. The example magnetic lock assembly includes features for conserving energy while maintaining a desired holding force to hold against an applied force.

### CROSS REFERENCE TO RELATED APPLICATION

This application claims priority to U.S. Provisional Application No. 61/187,390 that was filed on Jun. 16, 2009.

### BACKGROUND

This disclosure generally relates to magnetic locks. More particularly, this disclosure relates to a load sensing magnetic lock with a varying magnetic clamping force.

A magnetic lock includes an electromagnet and strike plate. The electromagnet is mounted in a fixed frame or member and the strike plate is mounted to the movable closure member. Current supplied to the electromagnet generates a magnetic force that holds the strike plate against a force applied to open the closure member. Locking and release of the closure member is therefore provided without a direct blocking mechanical linkage.

### SUMMARY

A disclosed magnetic lock assembly senses a load and varies a magnetic clamping force responsive to the sensed load. The disclosed magnetic lock operates at a low magnetic force that draws the least amount of power for most operating conditions. When a force is applied attempting to open the lock, the magnetic lock increases the magnetic force by drawing more power. The increased level of magnetic force is generated for short periods during the application of the force and therefore conserves power while maintaining a desired holding force to hold the lock closed against an applied force.

These and other features disclosed herein can be best understood from the following specification and drawings, the following of which is a brief description.

### BRIEF DESCRIPTION OF THE DRAWINGS

FIG. 1 is a top schematic view of an example gate closure assembly.

FIG. 2 is a front schematic view of example gate closure assembly.

FIG. 3 is a top schematic view of another example gate closure assembly configuration.

FIG. 4 is a perspective view of the example magnetic lock assembly.

FIG. 5 is a cross-sectional view of the example magnetic lock assembly.

FIG. 6 is a schematic of an example controller for the example magnetic lock assembly.

FIG. 7 is a graph illustrating operation of the example magnetic lock assembly.

FIG. 8 is another example controller for the example magnetic lock assembly.

FIG. 9 is a schematic view of another example magnetic lock assembly.

FIG. 10 is a graph illustrating operation of another example magnetic lock assembly.

### DETAILED DESCRIPTION

This disclosure is submitted in furtherance of the constitutional purposes of the U.S. Patent Laws ‘to promote the progress of science and useful arts” (Article 1, Section 8).

Referring to FIGS. 1 and 2, an example gate 10 is pivotally mounted within an opening of a fence 12 and is movable between open and closed positions. The example gate 10 includes a magnetic lock assembly 14 for holding the gate 10 in the closed and locked position. The magnetic lock assembly 14 includes an electromagnetic 16 mounted to a fixed portion of the fence 12 and a strike plate 18 mounted to the gate 10. The electromagnet 16 receives power from a battery 20. The battery 20 is limited in the amount of power it can provide for an extended time. A solar panel 22 provides for charging the battery 20 to maintain a desired level of charge. The electromagnet 16 is constantly powered to maintain the gate 10 in the closed position and therefore is a constant drain on the energy within the battery 20. The example magnetic lock assembly 14 includes features for conserving energy while maintaining a desired holding force to hold the gate 10 closed against an applied force.

As appreciated, although a battery 20 is shown by way of example for a power supply with a limited amount of power, other power supplies that are not constrained by limits on the amount of power would also benefit from the disclosures herein. Moreover, the disclosed example magnet lock 14 could be utilized within a structure that provides a continuous power supply such as is commonly found within a structure. Moreover, although a DC power supply is shown, an AC power supply could also be utilized with proper and know conditioning and converter modules. The power savings features of the example magnetic lock are therefore applicable in many different applications.

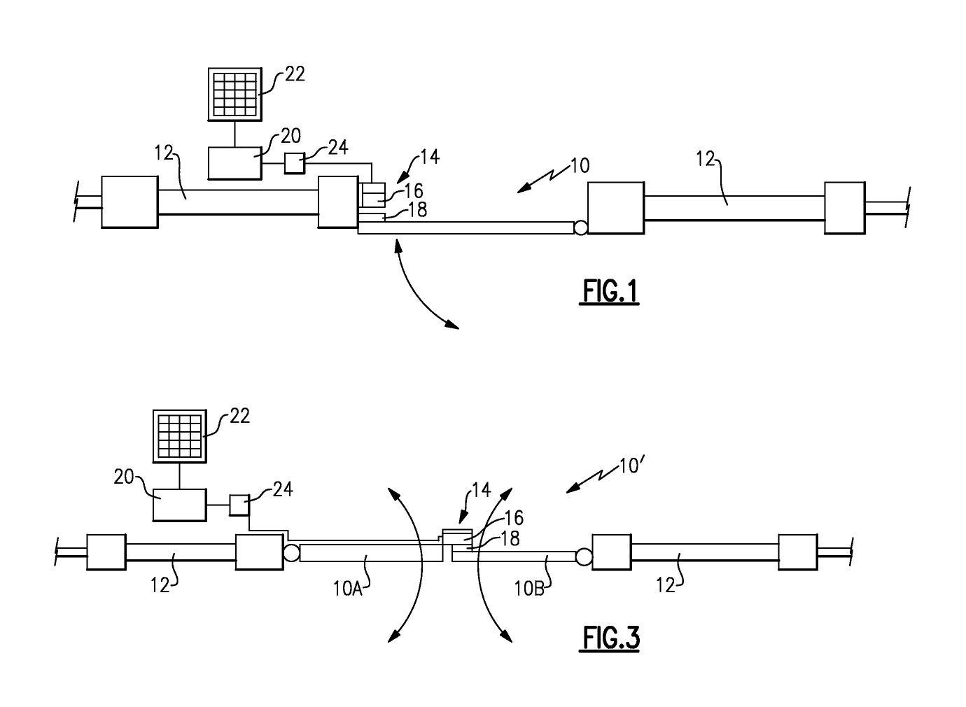

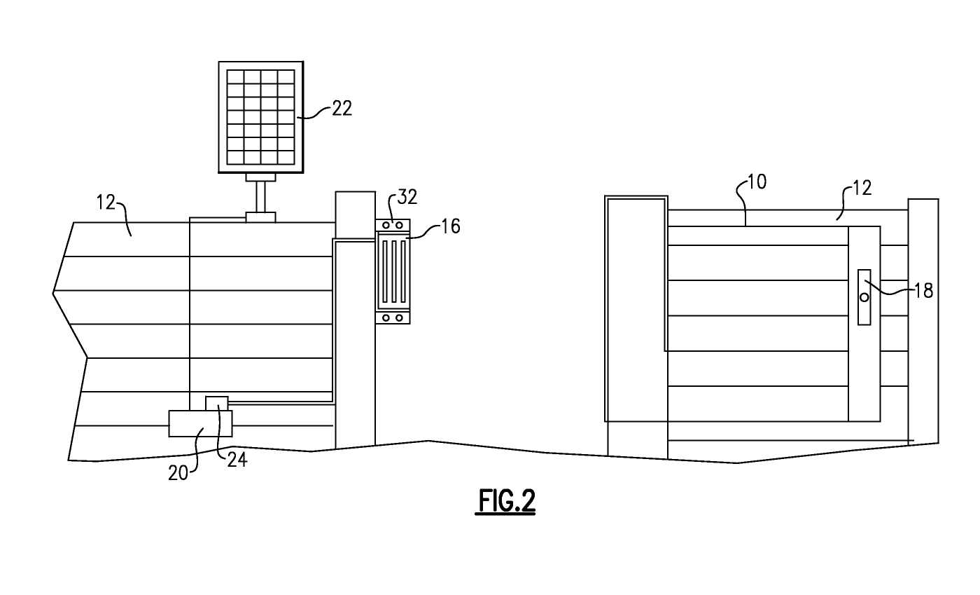

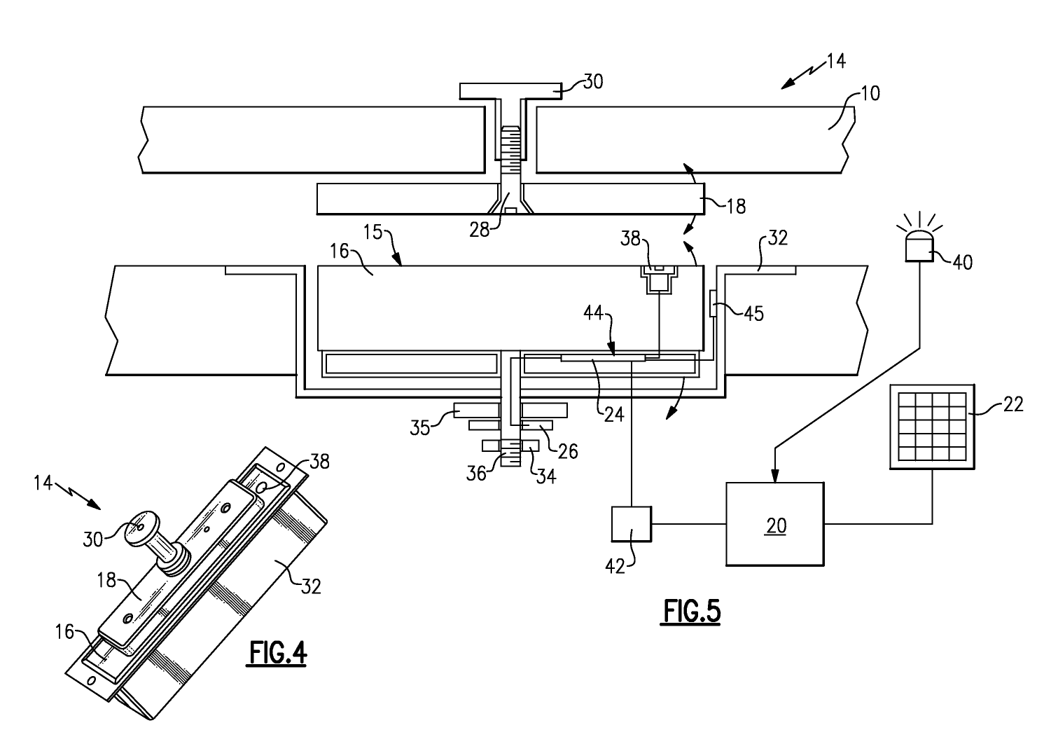

Referring to FIG. 3, the example gate 10′ includes two gate members 10A and 10B that meet at point between the fixed posts of the fence 12. In this example the electromagnet 16 is mounted to an end of one gate member 10A and the strike plate 18 is mounted to an end of the second gate member 10B. Accordingly, the example magnetic lock assembly 14 can be mounted for use in various gate configurations. Moreover, it is within the contemplation of this disclosure that the example magnetic lock 14 could be used for locking doors, windows and any other known closure members.

Referring to FIGS. 1-3, the magnetic lock 14 generates a magnetic force that attracts and holds the strike plate 18. Generation of the magnetic force by the electromagnet 16 requires a constant current draw from the battery 20. As appreciated, a battery 20 can hold only a limited, finite amount of energy. Therefore, in stand alone installations of the magnetic lock 14, it is desirable to reduce the amount of power utilized. Moreover, energy from the battery 20 may also be utilized for other devices such as gate openers and lighting devices, thereby further requiring the prudent use of available energy from the battery.

A controller, schematically shown at 24, controls the power provided to the electromagnet 16, and thereby the amount of magnetic force generated. During operation of the magnetic lock 14, it is only when a force is applied to open the gate 10 that high levels of magnetic force are required to hold the gate closed. The application of a force to open the gate 10 against the magnetic lock 14 is a rare occurrence and therefore the high levels of magnetic force required to counter such applied forces are only needed for small durations of time. The controller 24 controls the level of energy provided to the electromagnet 16 such that the force is at a minimum level of magnetic force that provides for keeping the gate 10 in the closed position in the absence of any applied force. The minimum level of magnetic force applied to the electromagnet 16 minimizes the energy draw from the battery 20 while still maintaining the gate 10 in the closed position.

The level of magnetic force generated is increased in response to a determination that a force is being applied to open the gate 10. As appreciated, in instances where it is desired to open the gate 10, the controller 24 will receive a signal that triggers release of the magnetic lock 14 such that no magnetic force is generated. However, if unauthorized opening is attempted, a force above that required to hold the gate 10 in the closed position is exerted by the magnetic lock 14. The disclosed magnetic lock 14 is provided additional energy from the battery 20 to increase the level of magnetic force to prevent and overcome the applied force to the gate 10.

Therefore, the disclosed magnetic lock 14 operates at a low magnetic force that draws the least amount of current from the battery 20 for most operating conditions. When a force is applied attempting to open the gate 10, the magnetic lock 14 increases the magnetic force by drawing more current from the battery 20. The increased level of magnetic force is generated for short periods during the application of the force. The increased level of magnetic force is maintained for a period after the release to maintain the gate 10 in the closed position.

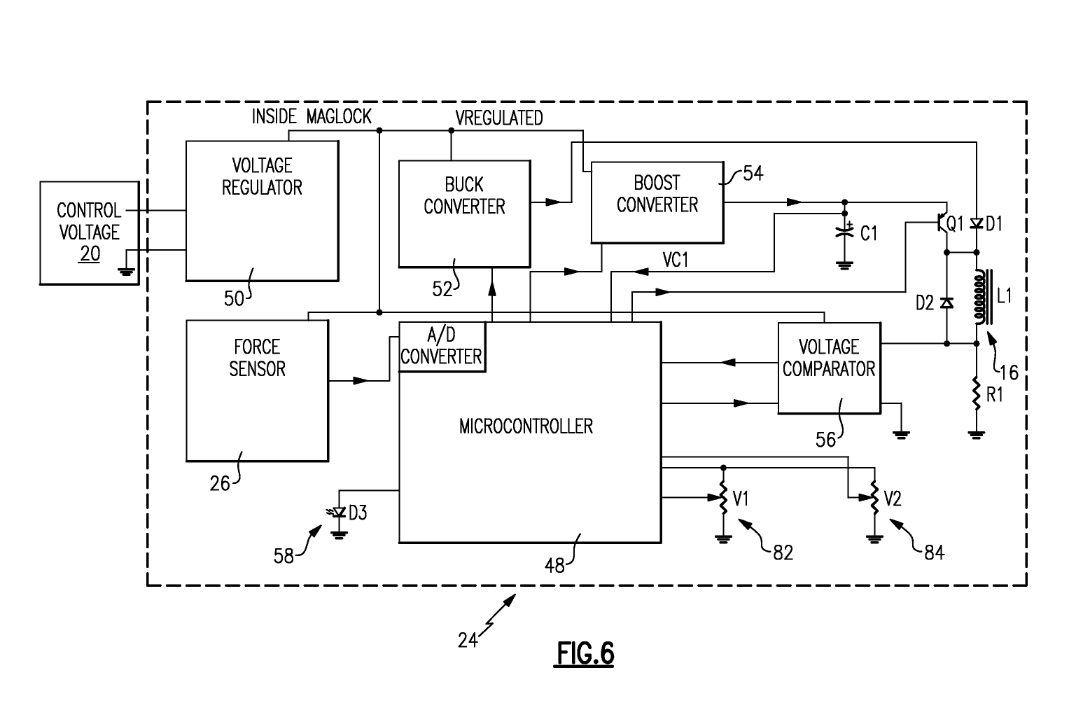

Referring to FIGS. 4 and 5, in order to ramp up the magnetic force produced by the electromagnet 16, the applied force must be first recognized. The example electromagnetic lock 14 includes a force sensor 26 that detects an applied force. In this example the force sensor 26 detects an applied force in a direction that could potentially separate the strike plate 18 from the electromagnet 16. The example force sensor 26 is a piezoelectric element that generates an electric current in response to pressure and/or deformation. The electric current is proportional to the amount of deformation, and thereby to the amount of force applied.

Alignment between the strike plate 18 and the electromagnet 16 is provided by allowing both the strike plate 18 and the electromagnet 16 some movement. Accordingly, the strike plate 18 is mounted to the gate 10 by screw 28 received within fastening member 30. The relationship between the screw 28 and fastening member 30 provide limited spherical movement of the strike plate 18.

The electromagnet 16 is movably supported within a housing 32 to provide some limited spherical movement. The housing 32 is rigidly attached to the gate 10 or fence structure 12. The electromagnet 16 is movable relative to the housing 32 to aid in achieving planer alignment with the strike plate 18. The electromagnet 16 includes a threaded member 34 that is received within a nut 36 that secures the electromagnet 16 to the housing 32 while providing the desired spherical movement. The threaded member provides single pivotal point of attachment that provides a limited amount of movement of the electromagnet 16. A compliant member 35 is disposed between the nut 365 and the housing 32 to prevent rattling while still allowing movement of the electromagnet 16 relative to the housing. Accordingly, a desired planar alignment between the electromagnet 16 and the strike plate 18 is provided by the mounting features of the strike plate and the electromagnet 16.

The example force sensor 26 is disposed between the compliant member 35 and the nut 34 on the threaded member 36 for detecting movement of the electromagnet 16 relative to the housing 32. In a locked condition, the strike plate 18 is in contact with a face 15 of the electromagnet 16. The magnetic force generated by the electromagnet 16 provides a significant holding or clamping force that maintains contact and resists separation. However, once the strike plate 18 moves away from the face 15 of the electromagnet, the magnetic holding force decreases quickly. In other words, once even a relatively small air gap is formed between the strike plate 18 and the electromagnet 16, the strike plate 18 will be free to move away from the electromagnet 16.

Pulling on the gate 10 with the electromagnet 16 and the strike plate 18 engaged, causes relative movement between the housing 32 and the electromagnet 16. This movement is detected by the sensor 26 and a signal indicative of the magnitude of the movement sent to the controller 24. Moreover, the compliant member 35 compresses to provide some displacement of the electromagnet 16 with the strike plate 18. The displacement provided by the compliant member 35 maintains the planar contact between the strike plate 18 and the electromagnet for a time in the presence of an external applied force. The compliant member 35 will compress a desired amount prior to hitting a hard stop against the back of the housing 32. Once the hard stop is contacted, the applied force will begin pulling the strike plate 18 from the electromagnet 16. The displacement and compression of the compliant member 35 delays this pulling apart for a desired time.

In response to detecting an external applied force, the controller 24 provides additional power to the electromagnet 16 to generate a magnetic force sufficient to overcome the applied and detected force. The time required to compress the compliant member 35 to delay the pulling apart of the strike plate 18 from the electromagnet 16 provides sufficient time for ramping up of the increased magnetic force.

The electromagnet 16 includes an adjustment screw 38. The adjustment screw 38 provides for calibration and adjustment of the magnetic field produced by the electromagnet 16. The adjustment 38 can be utilized to set the low level magnetic field utilized during periods where no force is applied attempting to open the gate 10.

The example electromagnet 16 is encapsulated in a non-magnetic material such as plastic or similar material. The example electromagnet 16 is configures as is know to generate a magnetic field in response to an applied current. The size, and therefore capability of the example electromagnet 16 can be tailored to application specific parameters. However, because the example electromagnet 16 is required to generate the highest forces for only brief periods, the overall size and steady state capability can be reduced as compared to electromagnet locks that maintain a constant force throughout the entire operating cycle.

The example force sensor 26 detects pressure and movement of the electromagnet 16 to determine the magnitude of the applied force attempting to open the gate 10. However, other sensing devices can be utilized that provide a signal that is indicative of an external applied force attempting to open the magnetic lock 14. A sensor may be utilized to detect changes in the generated magnetic field that are indicative of an applied force attempting to open the gate 10.

Further, a proximity sensor 40 may be utilized to sense the presence of an object or being around the magnetic lock 14. In this example, the proximity sensor 40 detects objects or being around the magnetic lock 14 as an indication of the potential for an applied force to be exerted on the magnetic lock 14.

A displacement sensor 45 could also be utilized to detect movement of the electromagnet 16. Movement of the electromagnet 16 provides a signal indicative of an external applied force, and therefore of potential unauthorized and undesired opening of the magnetic locks 14. The example displacement sensor 45 is shown mounted within the housing 45, but could also be mounted on the threaded member 36 in place, or in addition to the force sensor 26.

In addition, a current sensor 42 can be utilized for detecting a current draw from the battery 20. As appreciated, current from the battery 20 induces the desired magnetic field. Changes in the magnetic field that are created by relative movement between the electromagnet 16 and the strike plate 18 result in a corresponding change in current drawn from the battery. Changes in the current detected by the current sensor 42 can therefore be used to detect changes in the magnetic field that are indicative of an applied force attempting to open the gate 10. Moreover, it is within the contemplation of this disclosure that any sensor that provides a signal indicative of the actual or potential application of an external force to the magnetic lock 14 could be utilized to provide a trigger for the increase of magnetic holding generated by the electromagnet 16.

The example controller 24 shown in FIG. 5 is integrated on a circuit board 44 embedded within the electromagnet 16. The circuit board 44 includes the required components for conditioning and adjusting incoming current to produce the desired magnetic forces. Moreover, the example circuit board 44 includes features for managing dissipation of the magnetic field when opening is desired. As should be appreciated, although the example controller 24 is shown mounted within the electromagnet 16, the controller 24 could be a separate module as is illustrated in FIGS. 1-3, or can be part of a larger controller that controls other features such as gate opening or lighting.

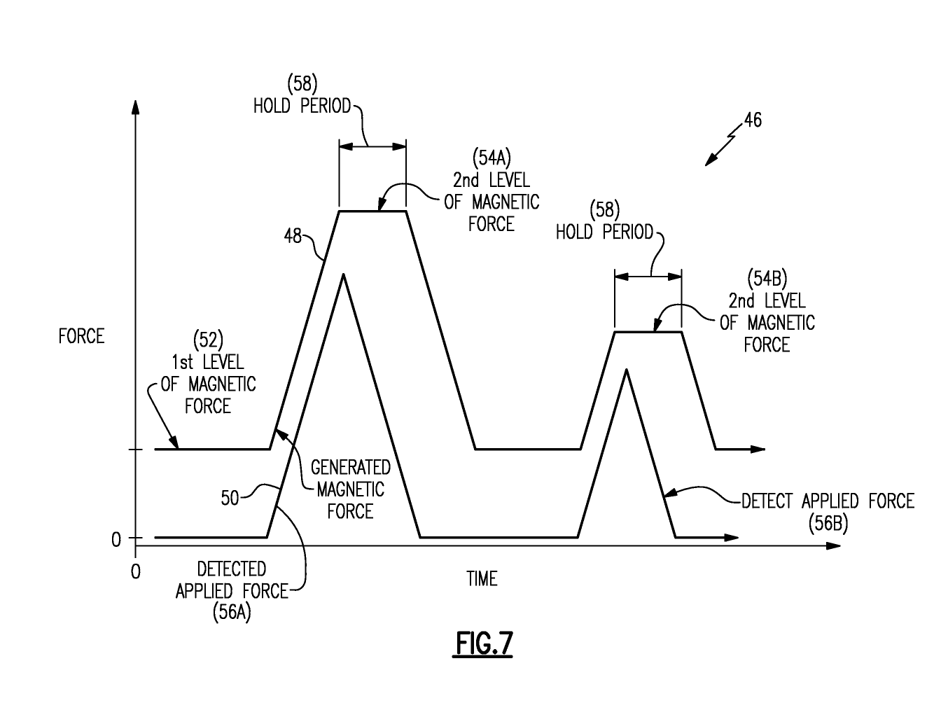

Referring to FIG. 6, the example controller 24 is schematically shown and includes components to control operation of the example magnetic lock 14. The example controller 24 includes a microcontroller 48 that is programmed to control a buck converter 52 and a boost converter 54 responsive to a force sensed by the force sensor 26. As appreciated, the signal from the force sensor 26 could be replaced or supplemented with other signals that provide an indication of an actually applied force, or a potential applied force in the case of data from the proximity sensor 40. A voltage regulator 50 conditions power received the power supply 20. The controller 24 includes a voltage comparator 56 that provides information utilized by the microcontroller 48 for controlling the power provided to the electromagnet 16. The buck converter 52 provides power to the electromagnet 16 to provide a low or minimum level of magnetic holding force. The boost converter 54 provides power to the electromagnet 54 to provide the higher magnetic holding force desired upon detection of an applied external force.

The microcontroller 48 uses the data provided by the force sensor 26, or other sensors, to perform the desires switching between the buck converter 52 and the boost converter 54. A status light 58 is provided and can be utilized for diagnostic and programming purposes. Further, the controller 24 includes an adjustment switch 82 for adjusting the holding current, thereby providing adjustment of the minimum magnetic force generated. Another adjustment switch 84 provides an adjustment of the high current that produces the highest magnetic force.

Referring to FIG. 7, the forces encountered during operation of the example magnetic lock 14 are schematically shown relative to time by graph 46. The electromagnetic lock 14 generates a magnetic force shown by line 48. The external applied force is shown by line 50. During operation when no applied force is present, the magnetic lock 14 generates a first level of force indicated at 52.

Upon detection of an applied force as shown at 56A, the magnetic force generated is ramped up to a second level as shown at 54A. The force is increased upon detection such that the magnetic force provided by the magnetic lock 14 is always greater than the applied force.

Once the applied force 56A is released, the magnetic lock 14 holds the second level of magnetic force 54A for a hold period 58 to assure that the lock remains in the clamped and hold position with the gate closed. As appreciated, unauthorized attempts to open the gate 10 are likely to be repeated pulling on the gate 10. Maintaining the force at the second level for the hold period 58 assures that repeated applied forces do not open the gate 10.

Upon a second applied force 56B, the magnetic force is moved to the second level 54B that is lower than the initial second level shown at 54A. As is shown, the lower second level is provided in proportion to the applied force 56B such that the force generated by the magnetic lock 14 is always greater than the applied force attempting to open the gate. The same hold period 58 is exerted to maintain the gate in the closed position. As appreciated, although example operation illustrates a proportional increase in magnetic field, it is also within the contemplation of this disclosure to increase the second level of magnetic force to a predetermined fixed strength. The predetermined fixed strength would be set to overcome a set desired applied force indicative of forces expected during an attempted unauthorized entry.

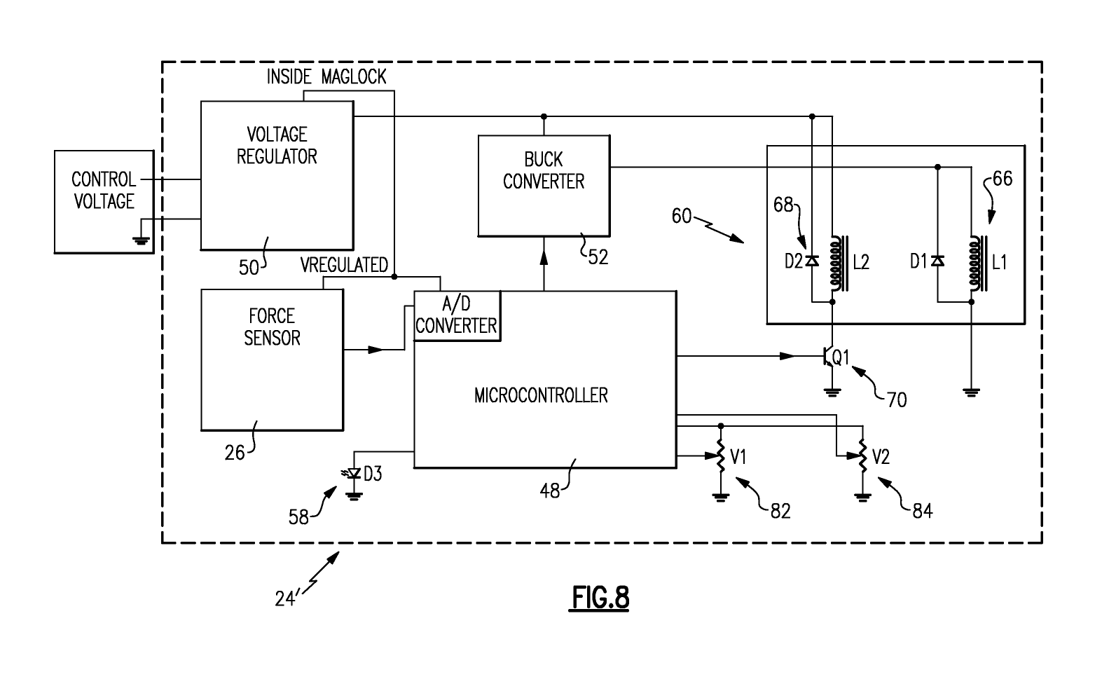

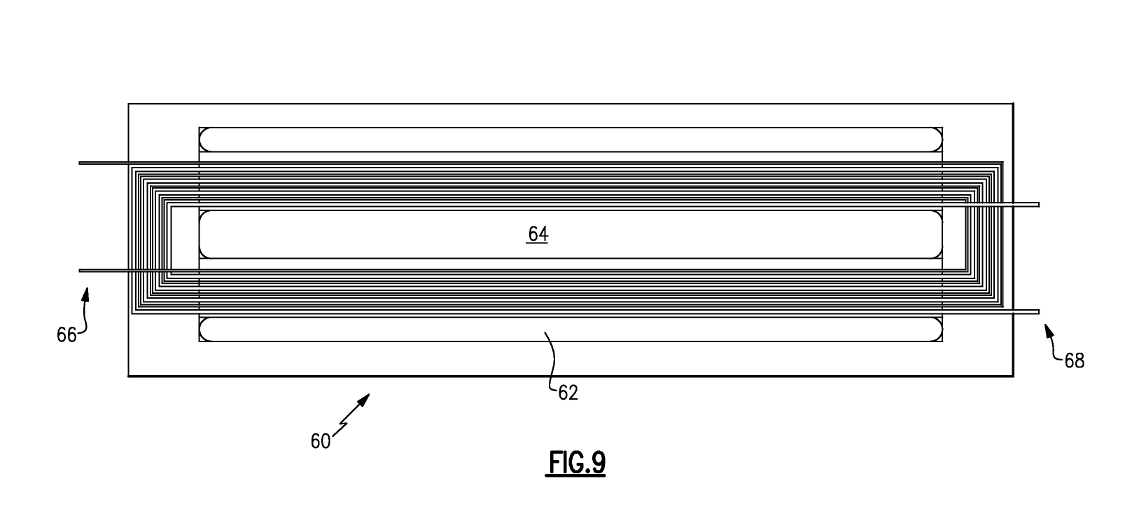

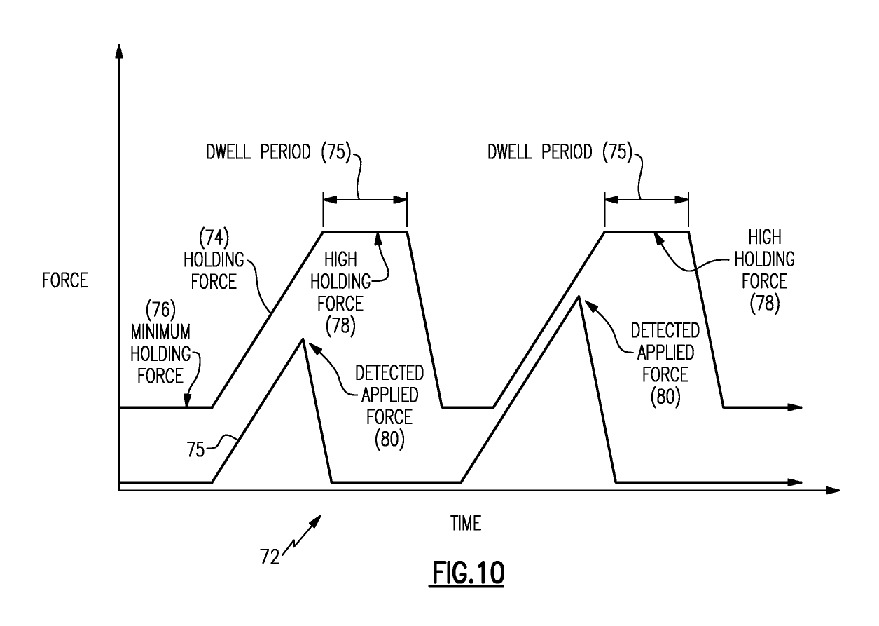

Referring to FIGS. 8 and 9, another example electromagnet 60 is schematically shown and includes a high resistance, low power coil 66 and a low resistance, high power coil 68. The controller 24′ switches between the coils 66 and 68 to provide the desired variable magnetic holding force. In this example, the microcontroller 48 is programmed to actuate switch 70 to turn on and off the high force coil 68. Initial locking of the magnetic lock 14 is provided by powering both the high power coil 68 and the low power coil 66. After a desired time without an applied external force, the microcontroller 48 actuates switch 70 to turn off the high power coil 68, leaving only the low power coil 66 on.

In response to a signal indicated an applied external force 26, or a potential applied external force indicated by detecting an object or being near the magnetic lock with the proximity sensor 40, the microcontroller 48 turns on the high power coil 68 to raise the magnetic holding force to a defined high level. This force can be held for a defined dwell period.

Referring to FIG. 10, graph 72 shows the magnetic holding force 74 compared to a detected applied external force 75. Initially, the low power coil 66 provides the minimum level of magnetic force. In response to a detected applied force as indicated at 80, the second high power coil 68 is turned on to provide a high holding force 78. The high holding force is not variable but is set at a level determined to prevent opening of the magnetic lock. The high holding force is held for a dwell period 75 such that the electromagnet 60 is not cycled between high and low holding forces unnecessarily. In this example, the high holding force 78 is not proportionate to the applied force, but is set at a fixed high level as is provided by the combination of the high and low force coils 68, 66.

Accordingly, the example magnetic lock assembly 14 provides a desired clamping and holding power while also conserving energy and current when high magnetic holding levels are not required. Moreover, the example magnetic lock 14 provides movement of both the electromagnet and the strike plate to provide a desired planar alignment.

Although an example embodiment has been disclosed, a worker of ordinary skill in this art would recognize that certain modifications would come within the scope of this disclosure. For that reason, the following claims should be studied to determine the scope and content of this invention.

What is claimed is:

1. A magnetic lock assembly comprising:
an electromagnet that generates a magnetic holding force;
a strike plate mountable to a closure member and attracted to the electromagnet;
a sensor generating a signal indicative of one of an applied force on the magnetic lock or a potential for a force to be applied to the magnetic lock; and
a controller for controlling the magnetic holding force between the electromagnet and the strike plate responsive to the signal indicative of one of an applied force on the magnetic lock or a potential for a force to be applied to the magnetic lock.

2. The assembly as recited in claim 1, wherein the magnetic holding force varies between a first magnetic force condition and a second magnetic force condition that is greater than the first magnetic force.

3. The assembly as recited in claim 2, wherein the first magnetic force condition comprises a holding force for holding the closure member in a closed position without an applied opening force and the second magnetic force condition comprises a holding force for holding the closure member in the closed position against an applied opening force.

4. The assembly as recited in claim 3, wherein the controller holds the electromagnet in the second magnetic force condition for a desired time after increasing from the first magnetic force condition.

5. The assembly as recited in claim 2, wherein the electromagnet comprises a low power coil generating the first magnetic force condition and a high power coil generating the second magnetic force condition.

6. The assembly as recited in claim 1, wherein the sensor comprises a force sensor that senses changes in pressure applied to the electromagnet.

7. The assembly as recited in claim 6, wherein the force sensor comprises a piezoelectric device mounted to the electromagnet.

8. The assembly as recited in claim 1, wherein the sensor comprises a proximity sensor that senses a presence of an object near the magnetic lock.

9. The assembly as recited in claim 1, wherein the force sensor comprises a sensor detecting a parameter indicative of a current supplied to the electromagnet.

10. The assembly as recited in claim 1, including a power source for supplying power to the electromagnet, wherein the power source comprises a limited amount of stored energy.

11. The assembly as recited in claim 10, wherein the power source comprises a battery.

12. A method of controlling operation of a magnetic lock assembly comprising:
generating a first level magnetic force with an electromagnet for holding a closure member in a closed position;
sensing a condition indicative of an applied force or a potential for force to be applied to the closure member; and
increasing the magnetic force from the first level to a second higher level in response to the sensed condition.

13. The method as recited in claim 12, including sensing a pressure between the electromagnet and the closure member and determining that a force is applied to the closure member responsive to a change in the sensed pressure.

14. The method as recited in claim 12, including sensing an proximity of an object near the magnetic lock and determining that a potential exists for applying a force the closure member responsive to detecting an object proximate the magnetic lock.

15. The method as recited in claim 12, including sensing a displacement of a some portion of the magnetic lock and determining that a force is applied to the closure member responsive to detecting a displacement of the portion of the magnetic lock.

16. The method as recited in claim 12, including holding the magnet force the second higher level for a desired time after the applied force has released.

17. The method as recited in claim 12, wherein the first level of magnetic force holds the closure member in the closed position in the absence of an applied force in a direction attempting to open the closure member, and the second higher level is at least greater than the sensed applied force to the closure member.

18. A gate closure assembly comprising:
a gate member moveable between open and closed positions;
a battery;
an electromagnet mounted to hold the gate member in the closed position, the electromagnet receiving electric power from the battery for generating a magnetic force;
a strike plate mounted to the gate member and movable into contact with the electromagnet;
a force sensor for sensing an applied force in a direction to move the gate member to an open position; and
a controller for controlling a level of magnetic force generated by the electromagnet, wherein the generated magnetic force is increased responsive to a sensed applied force.

19. The gate closure assembly as recited in claim 18, wherein the electromagnet generates a first level of magnetic force for holding the gate member in the closed position in the absence of an applied force and generates a second level of magnetic force greater than the first level of applied force for holding the gate member in the closed position in the presence of a sensed applied force.

20. The gate closure assembly as recited in claim 19, wherein the first level of magnetic force uses a first low level of power from the battery, and the second level of magnetic force uses a second level of power greater form the first low level of power from the battery.

21. The gate closure assembly as recited in claim 18, including a solar power generating device for charging the battery.

22. The gate closure assembly as recited in claim 18, wherein the electromagnet is mounted to a fixed structure and the strike plate is mounted to the gate member.

23. The gate closure assembly as recited in claim 18, wherein the gate member comprises a first gate and a second gate, wherein the electromagnet is mounted to the first gate and the strike plate is mounted to the second gate.

24. The gate closure assembly as recited in claim 18, wherein the electromagnet is mounted within a housing and is moveable relative to the housing to provide a desired relative alignment between the strike plate and the electromagnet.
